(19) United States
(12) Patent Application Publication
(10) Pub. No.: US 2024/0176326 A1
(43) Pub. Date: May 30, 2024

(54) METHOD AND SYSTEM FOR PROVIDING DATA

(71) Applicant: HOMAG GmbH, Schopfloch (DE)

(72) Inventors: Martin MEINTEL, Horb-Talheim (DE); Thomas ROTHFUSS, Pfalzgrafenweiler (DE); Michael VOLZ, Nagold (DE)

(21) Appl. No.: 18/283,799

(22) PCT Filed: Mar. 22, 2022
(86) PCT No.: PCT/EP2022/057463

§ 371 Date: Sep. 23, 2023

(30) Foreign Application Priority Data
Mar. 24, 2021 (DE) 10 2021 107 322.7

(51) Int. Cl. G05B 19/4155

(52) U.S. Cl. CPC G05B 19/4155; G05B 2219/31449

(57) ABSTRACT

Method for providing data from at least one machine-side data source (10) to at least one access point (20), comprising the steps of: setting up a data model (30), in which a predetermined definition and designation are stored for each of a plurality of machine-related parameters, storing the data model (30) in a data memory (50), setting up a first mapping (100) between source parameters of at least one machine-side data source (10) and machine-related parameters of the data model (30), and storing the first mapping (100) in a data memory (50).

### TECHNICAL FIELD

The invention relates to a method and a system for providing data from at least one machine-side data source to at least one access point.

### PRIOR ART

The keyword “Industry 4.0” describes the trend that more and more industrial objects, such as machines in particular, are being interconnected. On the one hand, machines can be interconnected with each other and, on the other hand, an interconnection with external access points can be provided so that, for example, the operator or manufacturer of the machine can access source data of the machine at any time and from any location.

In order to enable communication and data exchange between different systems, in which usually different “languages are spoken”, different concepts are discussed. One concept addresses the model-based development of so-called CPPS connectors which, based on the technology of software agents, translate and mediate between the languages of different systems connected in a CPPS network (cf. Schutz D., Vogel-Heuser B. (2017) “Modellbasierte Softwareagenten als Konnektoren zur Kopplung von heterogenen Cyber-Physischen Produktionssystemen”. In: Vogel-Heuser B., Bauernhansl T., ten Hompel M. (eds) “Handbuch Industrie 4.0” Vol. 2. Springer Reference Technik. Springer Vieweg, Berlin, Heidelberg. https://doi.org/10.1007/978-3-662-53248-5_93).

Such concepts are based on code generation and thus require intervention in the control software of the machine, the data of which are to be accessed. Furthermore, these concepts require that all data are present in a particular data specification, thus limiting the field of application and connectivity.

### DESCRIPTION OF THE INVENTION

The invention is based on the object of providing a method and a system for providing data, in which data can be provided in a simple and flexible manner from at least one machine-side data source to at least one access point.

According to the invention, this object is solved by a method for providing data according to claim 1 and a system for providing data according to claim 13. Particularly preferred further developments of the invention are specified in the dependent claims.

The invention is based on the idea of creating a kind of node as a basis for a wide variety of data transmissions, to which various machine-side data sources on the one hand and access points on the other hand can be connected in such a way that data transmission is made possible. For this purpose, a method according to the invention for providing data from at least one machine-side data source to at least one access point comprises the following steps: setting up a data model in a computer-aided manner, in which a predetermined definition and designation are stored for each of a plurality of machine-related parameters; storing the data model in a data memory; setting up a first mapping in a computer-aided manner between source parameters of at least one machine-side data source and machine-related parameters of the data model; and storing the first mapping in a data memory.

The data model works as a node, so to speak, which forms the basis for connecting one or more data source(s) with one or more access point(s). The configuration of the respective data connection can subsequently be carried out simply and quickly by setting up a suitable mapping, wherein a first mapping is firstly set up towards a machine-side data source.

This results in a particularly flexible connectivity, which is also easy to set up, of at least one machine-side data source with at least one access point. In particular, within the scope of the invention, an intervention in the control system (for example, PLC) of the machine is not necessary, and no specific software components have to be programmed and installed, although this is not excluded within the scope of the invention. This does not only have advantages during initial setup, but also simplifies maintenance of the machine since, for example, no new adjustments are necessary when updating the control system.

According to a further development of the invention, it is provided that a second mapping is set up in a computer-aided manner between machine-related parameters of the data model and target parameters of at least one access point, and that the second mapping is stored in a data memory. This is a further contribution to flexible and simple connectivity since, according to the invention, merely a configuration of the second mapping is necessary. Again, however, reprogramming or similar steps are unnecessary, which is associated with the above-stated advantages.

The first and the second mapping can comprise one or more mapping steps to bring about the above-stated parameter mappings. In this regard, it is particularly preferred that the first and/or second mapping comprises at least one step selected from allocating, linking, converting, transforming and logical mapping. In this regard, an allocation can, for example, also simply be the allocation of a fixed value. Possible conversions include a variety of formulas and algorithms. These mapping steps make it possible that virtually all desired parameter mappings can be performed precisely and quickly, thus ensuring the flexibility sought according to the invention.

Although mapping of parameters towards and based on the data model is provided according to the invention, it is additionally provided according to a further development of the invention that at least one machine-related parameter of the data model is calculated or derived from at least one other machine-related parameter of the data model. Thus, the data model can be further refined, without further mappings being necessary, and thus the method according to the invention is further simplified.

According to a further development of the invention, it is provided that a plurality of first mappings from different machine-side data sources and/or a plurality of second mappings to different access points are set up for the data model in a computer-aided manner and are each stored in a data memory. This makes it particularly clear that the method according to the invention can be used in a versatile manner for a wide variety of machine-side data sources and access points, and accordingly has a high degree of flexibility, without requiring any changes to the basic (control) software. In this regard, all logical mappings can be stored in the data memory or the logical mappings can be randomly distributed in the data memory.

The method is configured in a particularly simple and quick manner if, according to a further development of the invention, one template each is provided in a computer-aided manner for setting up a first and/or a second mapping in a computer-aided manner, which already includes at least some predefined parameter mappings. This makes it possible, for example, to provide an existing mapping as a template for similar or structurally identical machines, so that only individual parameter mappings to the properties of the next machine (such as a different serial number or different tools or units, for example) have to be set up in this template. On the one hand, this considerably increases the simplicity of the method, but on the other hand it also reduces sources of error.

In this regard, it is particularly preferred that further parameter mappings of at least one template are displayed and/or input at a user interface, wherein the further parameter mappings also relate to parameters that are individual to the respective machine-side data source or the respective access point. This makes it possible, for example, to upload a template onto the machine computer of a machine and to input only the missing parameter mappings for this specific machine (or this specific access point) at the user interface (e.g. monitor, keyboard, mouse, voice input interface, data interface, etc.). As already mentioned above, in some cases this can merely be a changed machine number, a changed delivery date, etc., or parameter mappings can also be input for parameters that result, for example, from modified units or other minor or major deviations between the machine to be configured and the template. Similar considerations apply accordingly to templates for different access points. In any case, the result is a particularly simple procedure that also does not require any special technical or programming knowledge, so that the method can also be carried out by less skilled or trained staff.

In principle, the above-stated data memories can be provided at any location and can also be part of a machine computer, for example. According to a further development of the invention, however, it is provided that at least one data memory is configured as cloud service and/or at least one data memory is accessed via a cloud service. In this regard, a cloud service is in particular to be understood as a service that is accessed via an Internet connection. In this way, not only hardware requirements can be reduced, but a particularly high flexibility in connectivity and access options also results. In addition, advantages regarding data backup can also be achieved.

Within the scope of the invention, a wide variety of data formats can be used and interconnected with each other. In this regard, it is particularly preferred that source parameters and/or target parameters are stored in a format, in particular transmission protocol, selected from OPC, OPCUA, MQTT, AMQP, REST, SOAP, MTConnect, OCCI, DAIS, ADS, GraphQL, CoAP, database connection such as in particular SQL, system calls (SysCalls) and combinations thereof. Individually and in combination, these formats have proven to be particularly effective for the reliable and precise transmission of data in the industrial sector and especially for machines.

Moreover, it is provided according to a further development of the invention that a data connection between the data memory, in which the first mapping is stored, and a data source of at least one machine is established, subsequently source data from source parameters of the machine are transmitted to the data memory, and finally model data are generated from the source data by means of the first mapping using a computing unit. By means of these steps, it is ensured that model data are provided on the basis of source data, which can subsequently be accessed without problems and in a standardized manner, without requiring complicated software modifications or the like.

In this regard, it is particularly preferred that target data are generated from the model data by means of the second mapping using a computing unit. Thus, a data set can again be generated in a particularly simple and flexible manner, which can subsequently be accessed with a desired access point without any further measures.

The method according to the invention has proven to be particularly advantageous if at least one machine comprises a unit for machining, processing and/or handling workpieces consisting preferably at least in parts of wood, wood materials, plastic or the like. Such machines as a rule have a large number of very different parameters, which are also generally not very standardized and which are often to be accessed by means of a wide variety of access systems. With regard to this highly heterogeneous variety of machines, the present invention provides the advantage that a simple and flexible access to the machine-side data is enabled.

A system for providing data, which has proven to be particularly advantageous for performing the method according to the invention and which effectively enables that the above-stated advantages are achieved, is the subject matter of the independent patent claim 12.

### BRIEF DESCRIPTION OF THE DRAWINGS

FIG. 1 schematically shows an embodiment of a system for providing data;

FIG. 2 schematically shows a further embodiment of a system for providing data;

FIG. 3 schematically shows various examples of source data, model data and target data.

### DETAILED DESCRIPTION OF PREFERRED EMBODIMENTS

Preferred embodiments of the invention will be described in detail below with reference to the accompanying figures. In this regard, identical reference numbers that are used in different figures refer to identical, corresponding or functionally similar elements.

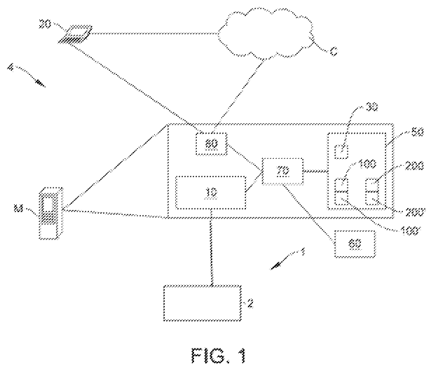

A system 4 for providing data from a machine-side data source 10 to an access point 20 is schematically illustrated in FIG. 1. The machine-side data source 10 refers to a machine 1 which constitutes, in the present embodiment, a machine for machining, processing and handling workpieces consisting at least in parts of wood, wood materials, plastic or the like. For this purpose, the machine 1 comprises, in the present embodiment, a unit 2 for performing the machining, processing and/or handling of the workpieces. For example, it can be a machine for formatting or coating workpieces or for conveying and storing workpieces. In this regard, it is to be noted that the type of machining, processing and/or handling is not limited within the scope of the present invention and a wide variety of configurations of the machine are possible.

In the present embodiment, the machine 1 is connected to a machine computer M which includes, inter alia, the components illustrated in FIG. 1 and contains, in particular, a machine-side data source 10. This data source provides a wide variety of machine-side parameters. In the present embodiment, the machine computer M further comprises a data memory 50 which can be formed, for example, by a hard drive (optionally SSD or the like), a RAM or a wide variety of other volatile or non-volatile storage media as well as combinations thereof.

Moreover, the machine computer M comprises a graphical user interface 60 which can comprise various input and output devices such as monitor, keyboard, pointing device, microphone, camera, speaker, etc. Moreover, there is a data interface 80 which can, for example, be a LAN or WLAN interface or optionally also a USB interface, etc. so that data can be exchanged with the machine computer M in a wide variety of ways.

Furthermore, the machine computer M has a computing unit (CPU) 70 to perform various operations within the machine computer M, which will be discussed in further detail below.

In the present embodiment, an external computer 20 is connected to the data interface 80, by means of which the machine-side data source 10 is to be accessed. Thus, the external computer 20 is a so-called access point which is often also designated as a so-called endpoint. The machine-side data source 10 is often also referred to as provider.

The computer 20 can be connected to the interface 80 of the machine computer M within a local area network (LAN/WLAN) and/or can also be connected via an Internet connection or other suitable remote data connection. In the present embodiment, the access point 20 is based on a data format of the OPCUA type, although a variety of other formats can also be used which are selected from OPC, MQTT, AMQP, REST, SOAP, MTConnect, OCCI, DAIS, ADS, GraphQL, CoAP, database connectivity such as SQL in particular, system calls (SysCalls) and combinations thereof.

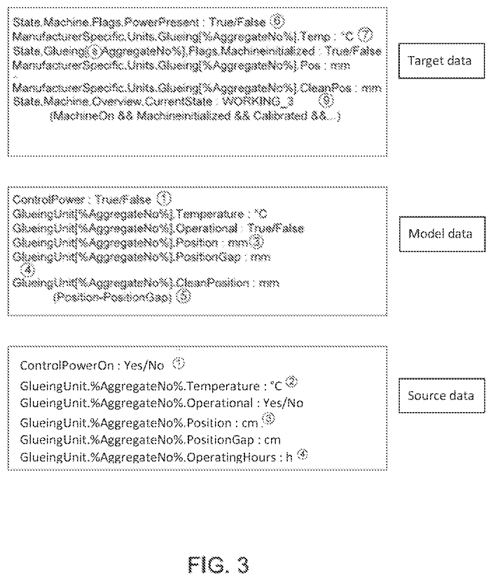

Based on the system shown in FIG. 1, the provision of data from the machine-side data source 10 to the access point 20 is carried out as follows, for example. First of all, a data model 30 is set up and stored in the data memory 50, wherein a predetermined definition and designation are stored for each of a plurality of machine-related parameters in the data model 30. An exemplary section of such a data model is illustrated in the center of FIG. 3. In principle, the data model 30 can be input by means of the user interface 60, but in practice it is more often transmitted to the machine computer via the data interface 80.

Subsequently, a first mapping 100 is set up and stored in the data memory 50. The first mapping 100 defines a mapping between the source parameters of the machine-side data source 10 and the machine-related parameters of the data model 30.

Furthermore, a second mapping 200 is set up and stored in the data memory 50, wherein the second mapping includes a mapping between the machine-related parameters of the data model 30 and the target parameters of the access point 20. As regards these sets of parameters, reference is made to FIG. 3 which illustrates not only a section of exemplary model data, but also corresponding sections of exemplary source data and target data. The respective lines of the illustrated boxes correspond to each other. Thus, the first mapping ensures that the first line of the source data (ControlPowerOn: Yes/No) is mapped to the first line of the model data box (ControlPower: True/False), whereas the second mapping ensures that the first line of the model data box (ControlPower: True/False) is mapped to the first line of the target data box (State.Machine.Flags.PowerPresent: True/False).

It is apparent from the examples shown in FIG. 3 that the first and the second mapping can each contain a wide variety of mapping steps, such as allocating, linking, converting, transforming and logical mapping, for example. In this regard, a conversion can include a wide variety of formulas and algorithms.

In the present embodiment, a first template 100′ and a second template 200′ are provided for setting up the first mapping 100 and the second mapping 200, which already contain several predefined parameter mappings. As apparent from FIG. 1, these templates 100′ and 200′ can be transmitted to the memory 50 of the machine computer M, for example by using the interface 80. Subsequently, further parameter mappings individual to the machine and/or specific parameter mappings for the computer 20 can be input, for example by using the user interface 60, in order to define on this basis the first mapping 100 and the second mapping 200. However, it is to be noted that the templates can also be completed elsewhere and complete first and second mappings 100, 200 can be uploaded onto the machine computer. Moreover, the templates can also contain additional parameters which may not be required or may not be defined for a specific machine.

After setting up the first and the second mapping 100, 200, the actual transmission of data can begin. For this purpose, a data connection between the data memory 50, in which the first mapping 100 is stored, and the machine-side data source 10 is established, and source data from source parameters of the machine are transmitted to the data memory 50. Subsequently, model data are generated from the source data by means of the first mapping 100 using the CPU 70. These can, for example, be temporarily stored in a RAM, which can be part of the memory 50, or in another suitable location, or these can be further processed directly.

Subsequently, target data are generated by means of the second mapping 200 on the basis of the generated model data using the CPU 70 and are transmitted via the interface 80 to the computer 20, either directly or via the Internet connection or Cloud C. On the computer 20, the data are directly available in the desired format and can be used immediately without any further intermediate steps or even programming.

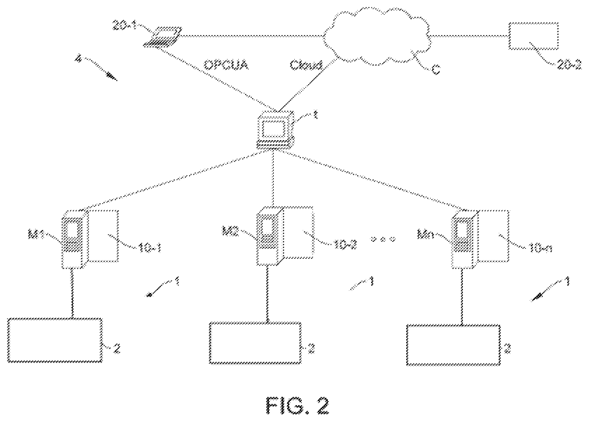

A second preferred embodiment of the invention is schematically illustrated in FIG. 2. First of all, it differs from the first embodiment in that a plurality of machines 1 is provided, each of which comprises a machine-side data source 10-1, 10-2, . . . 10-n. In the present embodiment, these machine-side data sources are in turn located in a respective machine computer M1, M2, . . . , Mn. In the present embodiment, the machine computers are in connection with a central computer Z which contains in particular the other components included in the machine computer according to FIG. 1 and is in data connection with the machine computers M1, M2, . . . , Mn. This data connection can in turn be local or can optionally also be established via the Internet or another suitable connection.

Further, the central computer is connected via a corresponding data connection, as already described with reference to FIG. 1, to a computer 20-1 which constitutes an access point to which data are to be provided from the machine-side data sources 10-1, 10-2, . . . , 10-n. Furthermore, FIG. 2 shows a further access point 20-2 which is connected to the central computer Z and optionally also to the access point 20-1 via an Internet or Cloud connection.

In all other respects, the structure and operation of the present embodiment correspond in principle to the structure and procedure described above with respect to FIG. 1. In this regard, it is to be noted that in principle any machine-side data sources 10-1, 10-2, . . . , 10-n can be accessed by means of each access point 20-1, 20-2 and optionally further access points that are not shown. The only prerequisite for this is that a suitable first mapping has been stored at a suitable location in the overall system for each machine-side data source, and that a suitable second mapping has been defined and stored at a suitable location in the overall system for each access point.

It is also to be noted that the various components of the overall system, such as the computing unit, memory, etc., as well as the various method steps can in principle be implemented anywhere in the overall system, and that even very different components can share certain tasks at different locations in the overall system.

In this regard, however, not all parameters of the data source have to be mapped to the data model (such as the last line of the source data box, for example). Furthermore, parameters of the data model can also result from other parameters of the data model, such as the last line in the model data box, for example. This also applies, for example, to the target data, such as the last line in the target data box.

Moreover, the present invention also makes it possible that data or commands are passed from an access point to a machine, again using the data model and the first and second mapping(s). In that case, the data transmission steps described above are in principle performed in reverse order.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. Method for providing data from at least one machine-side data source to at least one access point, comprising the steps of:
setting up a data model, in which a predetermined definition and designation are stored for each of a plurality of machine-related parameters,
storing the data model in a data memory,
setting up a first mapping between source parameters of at least one machine-side data source and machine-related parameters of the data model, and
storing the first mapping in a data memory.

2. Method according to claim 1, comprising the steps of:
setting up a second mapping between machine-related parameters of the data model and target parameters of at least one access point, and
storing the second mapping in a data memory.

3. Method according to claim 1, in which the first and/or second mapping comprises at least one step selected from allocating, linking, converting, transforming and logical mapping.

4. Method according to claim 1, in which at least one machine-related parameter of the data model is calculated or derived from at least one other machine-related parameter of the data model.

5. Method according to claim 1, in which a plurality of first mappings from different machine-side data sources and/or a plurality of second mappings to different access points are set up for the data model and are each stored in a data memory.

6. Method according to claim 1, in which one template each is provided for setting up a first and/or a second mapping, which already includes at least some predefined parameter mappings.

7. Method according to claim 6, in which further parameter mappings of at least one template are displayed and/or input at a user interface, wherein the further parameter mappings also relate to parameters that are individual to the respective machine-side data source or the respective access point.

8. Method according to claim 1, in which at least one data memory is configured as cloud service and/or at least one data memory is accessed via a cloud service.

9. Method according to claim 1, in which source parameters and/or target parameters are stored in a format, in particular transmission protocol, selected from OPC, OPCUA, MQTT, AMQP, REST, SOAP, MTConnect, OCCI, DAIS, ADS, GraphQL, CoAP, database connection such as in particular SQL, system calls (SysCalls) and combinations thereof.

10. Method according to claim 1, comprising the steps of:
establishing a data connection between the data memory, in which the first mapping is stored, and a data source of at least one machine,
transmitting source data from source parameters of the machine to the data memory, and
generating model data from the source data by means of the first mapping using a computing unit.

11. Method according to claim 10, comprising the steps of:
generating target data from the model data by means of the second mapping using a computing unit.

12. Method according to claim 1, in which at least one machine comprises a unit for machining, processing and/or handling workpieces consisting preferably at least in parts of wood, wood materials, plastic or the like.

13. System for providing data from at least one machine-side data source to at least one access point, in particular for performing the method according to claim 1, comprising:
an input interface for setting up a data model, in which a predetermined definition and designation are stored for each of a plurality of machine-related parameters,
a data memory for storing the data model,
an input interface for setting up a first mapping between machine-related parameters of the data model and source parameters of a machine-side data source,
a data memory for storing the first mapping, and
a computing unit for generating model data from the source data by means of the first mapping.
